(19) United States
(12) Patent Application Publication
(10) Pub. No.: US 2005/0121952 A1
(43) Pub. Date: Jun. 9, 2005

(54) Contour motorcycle seat

(76) Inventor: Jerzy Hajduczyk, Kenosha, WI (US)

Correspondence Address: JERZY HAJDUCZYK, 7710 5th AVENUE, KENOSHA, WI, 53143, US

(21) Appl. No.: 10/902,410

(22) Filed: Nov. 29, 2004

Related U.S. Application Data
(60) Provisional application No. 60/494,112, filed on Aug. 12, 2003.

(51) Int. Cl. B62J 1/00

(52) U.S. Cl. 297/195.1

(57) ABSTRACT

A motorcycle seat which has a contoured middle part in such a way that it forms a valley for each, the driver and a passenger. The middle section of the seat, usually foam or foam like material is carved out to form the valley. The seat cover, usually leather or leather like material properly tailored is stretched over the foam and attached by screws, nails, staples or glue to the seat base, a hard plastic mold or metal. In the front part of the seat occupied by the driver, one channel on each side , made of 1″ PVC tubing, are inserted through the foam to provide air venting to the middle valley.

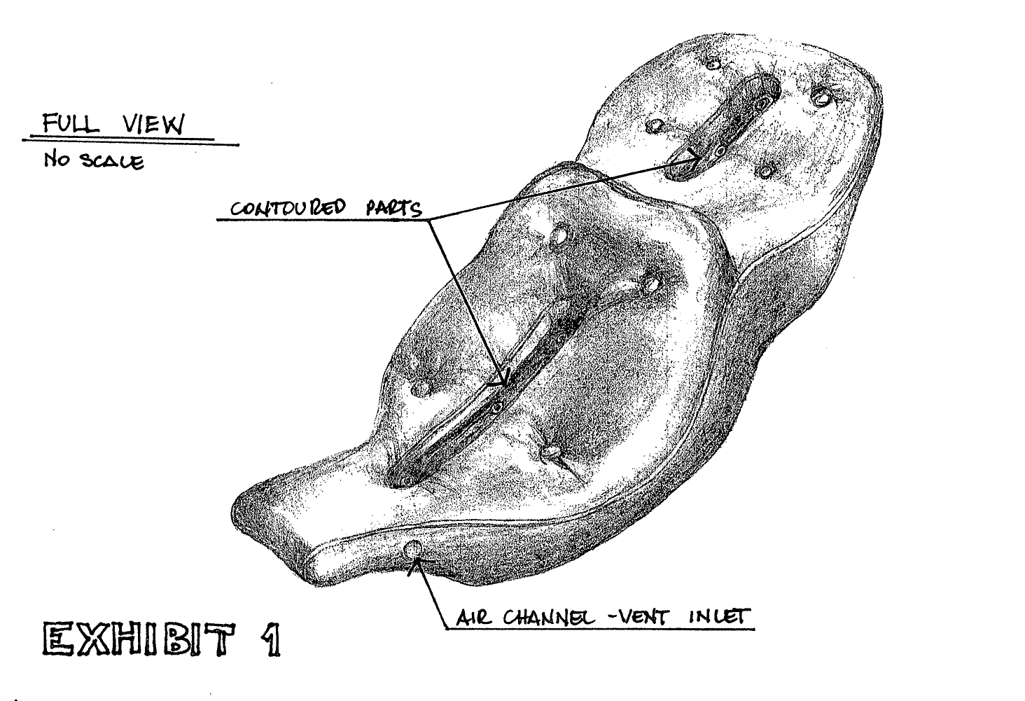

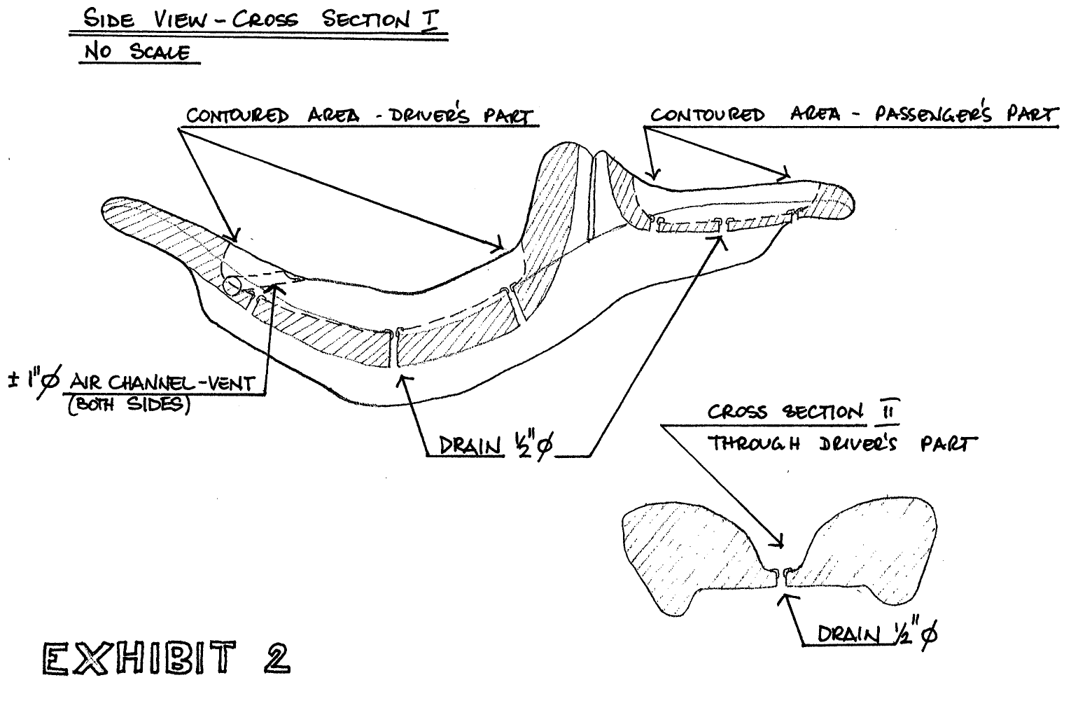

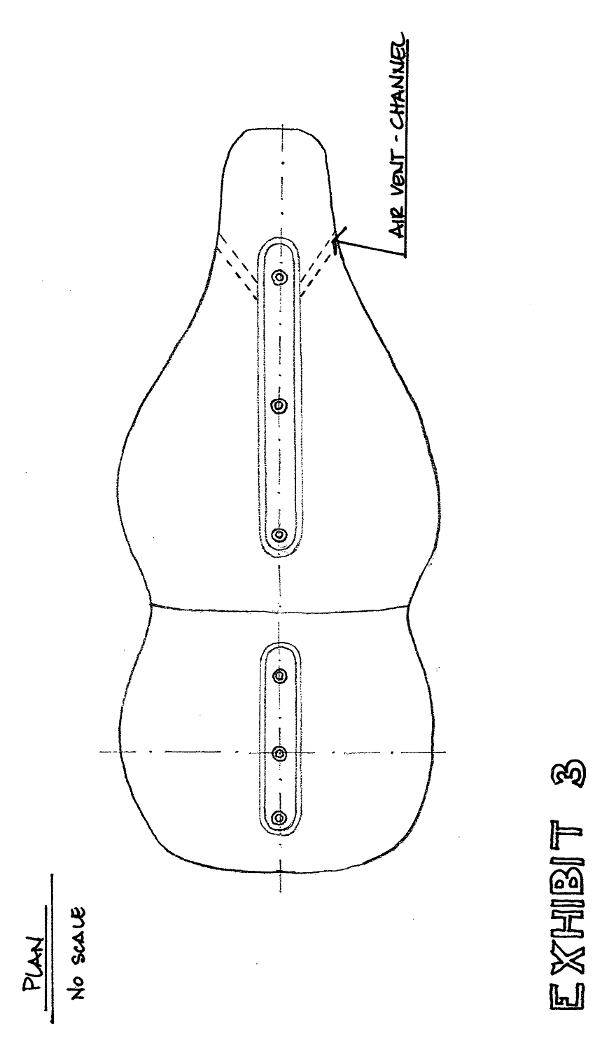

### O1. CROSS REFERENCE TO RELATED APPLCIATIONS

Motorcycle is one of the most common motor vehicles in the world. This is also true for the United States. Millions of riders and passengers make millions of trips every day. Many of those trips are long where the rider and passenger have to sit on conventional seat for many hours at a time. Typical conventional motorcycle seat is profiled so that sitting on such a seat for hours at a time may cause riders and passengers to develop extreme fatigue. There are several causes of such fatigue:

1. Pressure is exerted on rider's and/or passenger's genital area. This causes discomfort for both male and female riders and/or passengers.

2. There is a significant heat buildup in the genital area especially on hot days.

3. Pressure is exerted on the tailbone, and that can cause pain and discomfort.

4. As pressure is exerted on the tailbone, vibration from the motorcycle engine and road surface is transmitted up the spine, and that also can cause pain and discomfort all the way up to the neck.

5. Due to pressure and heat buildup persons with hemorrhoidal problems suffer additional discomfort.

6. Heat buildup may cause riders to move or slide around the conventional seat and that can cause safety problems as attention is diverted from the situation on the road.

### 02. BACKGROUND OF THE INVENTION

The inventor has been riding motorcycles for many decades. He has developed serious back problems, not related to riding motorcycles, and has flaring hemorrhoids. He has over the years been forced to reduce riding due to back and neck pain and swelling and flaring of hemorrhoids, especially on long rides. He has tried many ways to reduce those problems and finally in the year 2002 has developed the Contour Seat. He has tested it for a year and last year has filed provisional application and the US Patent Office has assigned this application No. 60,492,112 with a filing date of Aug. 1, 2003.

### 03. SUMMARY OF THE INVENTION

Some of the problems associated with riding a motorcycle on a conventional seat and listed above are significantly reduced and/or overcome. The Contour Motorcycle Seat has a elongated depression through the middle. Driver's and passenger's genital area and tailbone area are not touching the seat cover and the driver's weight is all distributed through the buttocks. Thus pressure applied to the genital and tailbone areas is significantly reduced, so is the heat buildup. Rider's and/or passenger's weight rests entirely on buttocks where vibration is better absorbed. In addition an air venting channel is built into the seat providing added ventilation and cooling. In the bottom of each depression there is at least one drain hole to evacuate any liquids that might enter the depression.

### 04. BRIEF DESCRIOPTION OF ATTACHED DRAWINGS

There are 3 drawings, referred to as Exhibits and numbered 1 through 3.

EXHIBIT 1: A perspective view of a contoured motorcycle seat.

The Contour Seat has two contoured depressions, one for the rider, and this depression is 10-12 inches long and some 2.5 inches deep. The depression for passenger is 6-8 inches long and also about 2.5 inches deep. Both depressions have drain holes to evacuate any liquid that might enter the depression. Additionally, an air channel is included on each side to provide ventilation to the depressions.

EXHIBIT 2: Side view—Cross section

This drawing provides detailed cross section and shows depressions, air vent and drain holes.

EXHIBIT 3: Plan,

This drawing provides bird's eye view of the seat.

This invention can also be used for “single” motorcycle seats, where only the front part presented here can be build this way.

1. I claim that my invention will give motorcycle rider and/or passenger better comfort by significantly reducing pressure on genital and tailbone areas. The seat profile causes weight of the driver and/or passenger to be distributed mainly through the buttocks.

2. I claim that my invention provides more ventilation to the genital and tailbone areas. This causes more comfortable ride especially on long distances.

3. I claim that my invention causes the tailbone not touch the seat cover. This reduces vibration transmitted through driver and/or passenger up the spine reducing fatigue.
